(19) United States
(12) Patent Application Publication
(10) Pub. No.: US 2013/0122447 A1
(43) Pub. Date: May 16, 2013

(54) Method for Making and Using Aligners for Orthodontic Treatments

(71) Applicant: Marc Lemchen, New York, NY (US)

(72) Inventor: Marc Lemchen, New York, NY (US)

(21) Appl. No.: 13/677,048

(22) Filed: Nov. 14, 2012

Related U.S. Application Data
(60) Provisional application No. 61/559,644, filed on Nov. 14, 2011.

(51) Int. Cl. A61C 7/08

(52) U.S. Cl. CPC A61C 7/08
USPC 433/24

(57) ABSTRACT

A method for applying orthodontic forces to one or more teeth using a single model of the tooth or teeth which are to be moved. The model chosen is the final corrected configuration for the patient as determined by their oral health care provider and comprises the final position and orientation of the tooth or teeth to be achieved after a successful treatment regimen. A series of aligners are made which each comprise the corrected configuration. Each successive aligner in the series is comprised of a selectively stiffer material than the previous aligner in order to move the tooth or teeth into the final desired position. As the patient's treatment progresses, the patient receives the next successive aligner which is incrementally more rigid or stiff than the previous aligner, thus effectuating the movement of the tooth or teeth to their desired final position and orientation.

### RELATED APPLICATIONS

The present application is related to U.S. Provisional Patent Application Ser. No. 61/559,644, filed on Nov. 14, 2011, which is incorporated herein by reference and to which priority is claimed pursuant to 35 USC 119.

### BACKGROUND

1. Field of the Technology

The disclosure relates to the field of orthodontic treatments, specifically to removable aligners which are used to correct position of one or more teeth.

2. Description of the Prior Art

An aligner as shown in FIG. 1 is a removable orthodontic appliance which is typically made of a clear polymeric material and functions as clear orthodontic braces. The aligner is a removable orthodontic appliance that incorporates a series of individual fittings, also called an aligner, that fits comfortably over the tooth and which is designed to move the teeth gradually into a desired orthodontic position as determined by conventional orthodontic principles.

The use of a series of removable aligners for the adjustment of occlusion (bite) was first introduced in the 1940s and was further developed in the 1970s to employ a series of dental impressions from the patient to determine the optimal position of the teeth. Another method is that used by Invisalign® which requires only one set of impressions and photographs of the teeth to be taken during an initial consultation. These initial impressions are used to create a three-dimensional computer projection of how the teeth could be moved incrementally, forming the basis for developing a series of custom-made aligners designed to accomplish this movement.

Aligners are manufactured in a dental laboratory using computer-aided design/computer-aided manufacturing (CAD/CAM) processes. According to the prior art methodology, the aligners are sent to the dentist after manufacture, who typically distributes them to the patient in groups of one or two at a time during regular check-up appointments (about every four to six weeks) so that treatment can be properly managed. Each aligner must be worn in its specific order for about two weeks, during which time it moves the teeth in small increments of about 0.25 millimeters to 0.33 millimeters.

Although the aligners are removable so that the user may eat, drinking certain beverages, and perform other tasks such as brushing and flossing, they must be worn at least 20 hours a day in order to reposition the teeth successfully. A typical prior art treatment therefore requires 20 to 30 aligners for both the upper and lower teeth. Most adults complete their treatment in less than one year. However, treatment time also depends on the specific alignment problem. Therefore, it is important to realize that the series of 20-30 aligners is made with the tooth or teeth in incrementally shifted positions or orientations, gradually building to the final corrected position.

Typically, all of the aligners used during treatment are made of a single type of material with a fixed stiffness. The amount of force or torque applied to the tooth or teeth by the aligner is determined by the incremental difference between the current position or orientation of the teeth and the orientation which has been modeled into the selected one of the series of aligners. In this manner, the tooth and/or teeth are slowly urged into position by a series of changing shapes of aligners, and much like still frames in a motion picture, each aligner progresses the patient's treatment in an incrementally different configuration until the final position is reached.

While these prior treatment methods are not without their respective successes, their use necessarily requires a plurality of aligners to be made, each successive aligner comprising a slightly different molded shape. Because each aligner used during treatment is unique, this dramatically increases the cost of treatment. What is needed therefore is a method for applying orthodontic forces to teeth that uses a plurality of aligners which are made from a single mold or master template that dramatically reduces manufacturing costs.

### BRIEF SUMMARY

A method for applying orthodontic forces to at least one tooth of a patient. The method includes fabricating an orthodontic mold for the at least one tooth. The orthodontic mold comprises a configuration which applies orthodontic forces to move the at least one tooth to a final desired position. A series of aligners derived from the orthodontic mold are made, wherein each successive aligner in the series comprises an increased rigidity. The series of aligners are applied in succession to the at least one tooth of the patient until reaching the final aligner in the series, wherein the final aligner has the greatest amount of rigidity out of the entire series of aligners.

The configuration of the orthodontic mold comprises the final position and orientation of the at least one tooth to be moved.

In one embodiment, the series of aligners derived from the orthodontic mold are fabricated so that the thickness of each of the aligners is varied so that each successive aligner in the series is increasingly rigid.

In another embodiment, the series of aligners derived from the orthodontic mold are fabricated out of plastic or polymeric material and are varied in their composition so that each successive aligner in the series is increasingly rigid.

In yet another embodiment, the series of aligners derived from the orthodontic mold are fabricated from a plurality of laminate layers and are varied in the number of laminate layers used so that each successive aligner in the series is increasingly rigid.

Applying the series of aligners in succession to the at least one tooth of the patient also includes exchanging a first aligner in the series for the next successive aligner in the series. The next successive aligner having an increased rigidity over the first aligner. The aligners are continually exchanged a for the next aligner in the series as needed until the final aligner in the series is received.

The invention also includes a method for applying orthodontic forces to at least one tooth of a patient which includes fabricating a series of orthodontic molds for the at least one tooth. Each orthodontic mold comprises a configuration to apply orthodontic forces to move the at least one tooth to a desired position. A sub-series of aligners corresponding to each of the series of orthodontic molds are also fabricated, wherein each successive aligner within each sub-series has an increasing rigidity. Each sub-series of aligners corresponding to the series of orthodontic molds are then applied in succession to the at least one tooth of the patient.

Each sub-series of aligners are applied in succession to the at least one tooth of the patient by first applying a first sub-series of aligners to the at least one tooth, wherein the first sub-series of aligners correspond to the configuration of a first orthodontic mold. Within the first sub-series of aligners, the each aligner is applied for a specified amount of time until it is exchanged for the next aligner in the sub-series. This process repeats until the final aligner in the sub-series is received. The entire first sub-series of aligners are then exchanged for a next successive sub-series of aligners, the next successive sub-series of aligners corresponding to a different, successive orthodontic mold. The sub-series of aligners are continually exchanged for the next sub-series of aligners corresponding to the next successive orthodontic mold until the final sub-series of aligners corresponding to a final orthodontic mold is received.

For each sub-series, the method also includes applying each sub-series of aligners in succession to the at least one tooth of the patient by exchanging a first aligner in the sub-series for a next successive aligner in the same sub-series of aligners. The next successive aligner which is used has an increased rigidity over that of the first aligner.

In one embodiment, each of the sub-series of aligners which are derived from each of the series of orthodontic molds are fabricated so that the thickness of the aligners in each sub-series is varied so that each successive aligner within each sub-series is increasingly rigid.

In another embodiment, each of the sub-series of aligners which are derived from each of the series of orthodontic molds are fabricated out of plastic or polymeric material and are varied in their composition so that each successive aligner within each sub-series is increasingly rigid.

In yet another embodiment, each of the sub-series of aligners which are derived from each of the series of orthodontic molds are fabricated from a plurality of laminate layers which are varied the number of laminate layers used so that each successive aligner within each sub-series is increasingly rigid.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a perspective view of the aligners currently used in the prior art.

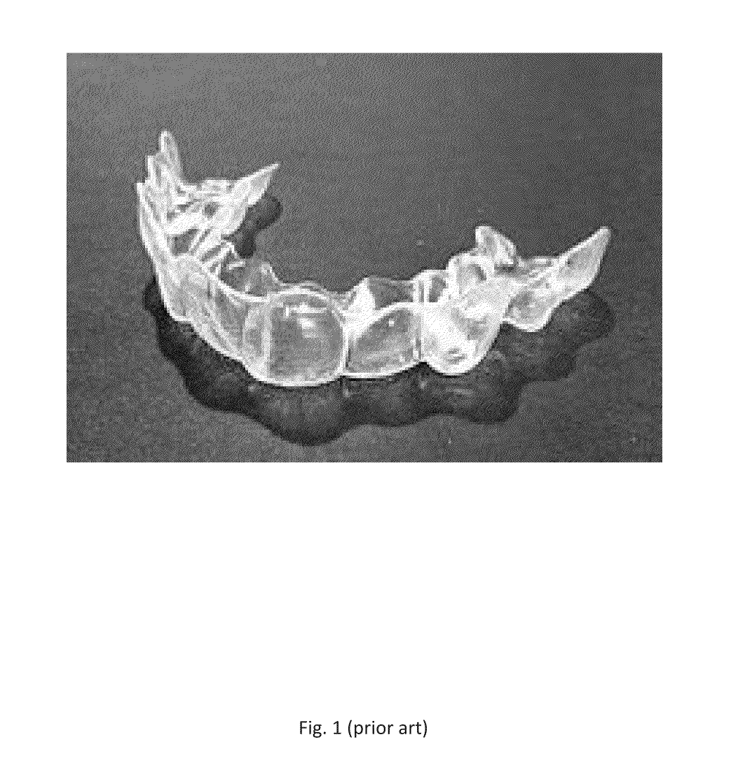

FIG. 2 is a flow chart of one particular embodiment of the invention comprising fabricating a single orthodontic mold.

FIG. 3 is a flow chart of an alternative embodiment of the invention comprising fabricating a plurality of orthodontic molds.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

Instead of making a series of aligners where each is aligner made on a computer or hand generated model with a tooth or teeth moved progressively into a desired position, the current method uses a single model of the tooth or teeth that are to be moved. The model made is the final corrected configuration for the patient as determined by their oral health care provider. The corrected configuration comprises the final position and orientation of the tooth or teeth to be achieved after a successful treatment regimen. Once the corrected configuration has been determined by the oral health care provider, a series of aligners all comprising the corrected configuration are made wherein each successive aligner is comprised of selectively stiffer material than the previous aligner in order to move the tooth or teeth into the final desired position.

Each aligner is comprised of a plastic or polymeric material. The stiffness of the plastic or polymeric material can be adjusted according to well known conventional principles known to those skilled in the art.

In one embodiment, the stiffness between successive aligners is varied by varying the thickness of the walls of the aligner. The thicker the walls, the more rigid the aligner with a given type of plastic or polymeric material will be. It is to be expressly understood that the specific type of plastic or polymeric material may be any dental plastics now known or later devised without departing from the original spirit and scope of the invention. For example, the materials manufactured by Dentsply Raintree Essix Glenroe, a division of Dentsply International of Sarasota, Fla., can begin to provide a sense of the variety of materials available to those skilled in the art.

In another embodiment, the selected stiffness or rigidity of the aligner may be had by varying the composition of the plastic or polymeric material in combination with varying the thickness of the walls of the aligner.

In another related embodiment, the aligner is comprised of a varied or different rigidity in specific parts of the aligner itself. For example, if the patient's treatment requires movement of the upper right central incisor, the portion of the aligner on either side of the upper right central incisor would be thick and less flexible, assuring that the adjacent teeth do not move and supply the necessary force to move the selected tooth. The aligner is more flexible or is comprised of a thinner material to allow the appliance to fit over (i.e., engage or envelope) the tooth to be moved and apply a targeted pressure. The aligner may also comprise segments of varied rigidity. For example, the aligner would comprise a greater stiffness in one area over another adjacent area such as being stiff and inflexible on the back teeth, but very flexible on the anterior teeth allowing the back teeth to hold the appliance “down” while the flexible part applies the forces to align the front teeth.

In another embodiment, the aligner is comprised of a plurality of laminate layers of varying inherent stiffness and/or thicknesses to obtain an overall variation of stiffness in the complete aligner. For example, a first aligner may comprise three layers of laminate material and provide a certain amount of rigidity. However when the patient requires the next aligner needed for his treatment regimen, the new aligner may for example comprise five layers of laminate material so as to be inherently more rigid then the previous aligner, thus advancing the patient's treatment.

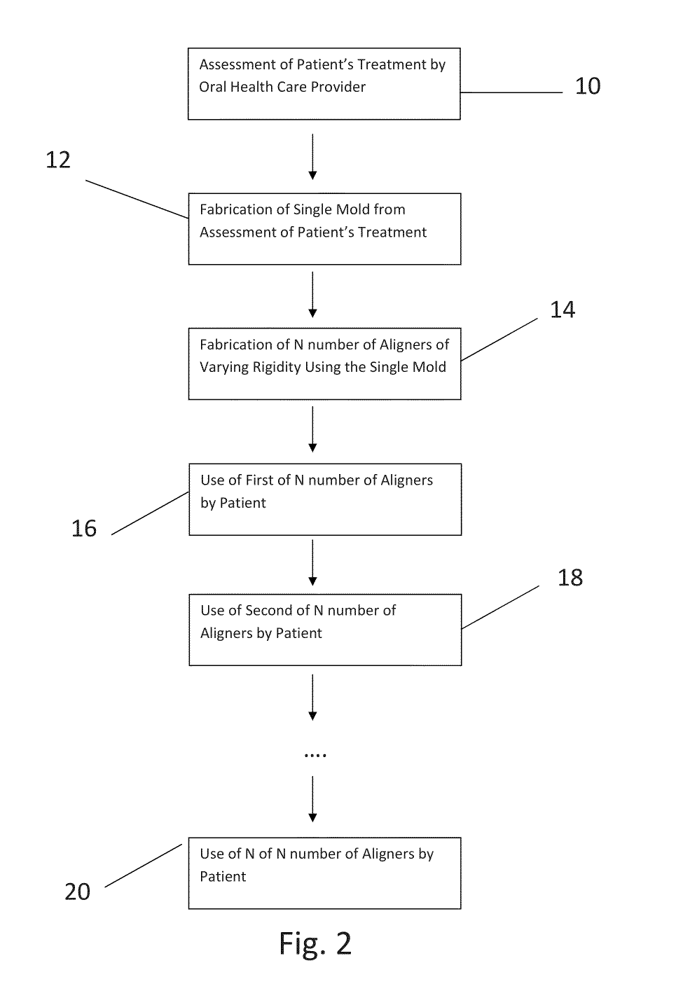

Each successive aligner which used in treatment however, while being varied in the number of laminate layers present or thickness, are based on the same template or model of the patient's teeth that was originally provided to the oral health care provider. In other words, only one final mold or aligner model needs to be made for any given patient and it is the formulation of the aligner itself, rather than the mold, which is changed as the treatment progresses. Further understanding of this process may be had by turning to FIG. 2. Typically treatment is started in step 10 by an oral health care provider assessing the patient's teeth and developing a treatment regimen or prescription for moving the patient's teeth into a final desired position. A master mold or template comprising the prescribed treatment regimen is then fabricated in step 12. A series of flexible or soft aligners, each comprising the prescribed configuration, are made in step 14. The exact number of aligners that are made, N, is decided by the oral health care provider according to the treatment appropriate for each individual patient. Each aligner that is made within the series is increasingly rigid or is comprised of a stiffer material is so as to advance the treatment of the patient. For example, in step 16, the patient is given the first, and therefore the softest, aligner of the series of aligners that was made from the mold in step 14. After the prescribed use of time for the first aligner has elapsed, the patient is given the second aligner in the series in step 18. The second aligner is necessarily stiffer or more rigid than previous aligner used by the patient in step 16. The patient continually exchanges aligners for the next one in the series as needed until, as seen in step 20, he reaches the last aligner N that was fabricated from the master mold in step 14. The final aligner N is then the stiffest or most rigid of the series of aligners made during fabrication step 14. After using the last aligner N, and assuming proper patient compliance, the patient's tooth or teeth will now be in the final desired position as dictated by the configuration in the master mold that was made in step 12.

As a result the amount of time required for designing the aligner and the related cost of making a single mold as opposed to a series of aligners, is dramatically reduced. These savings are then passed on to the patient, further reducing the cost of the overall orthodontic treatment.

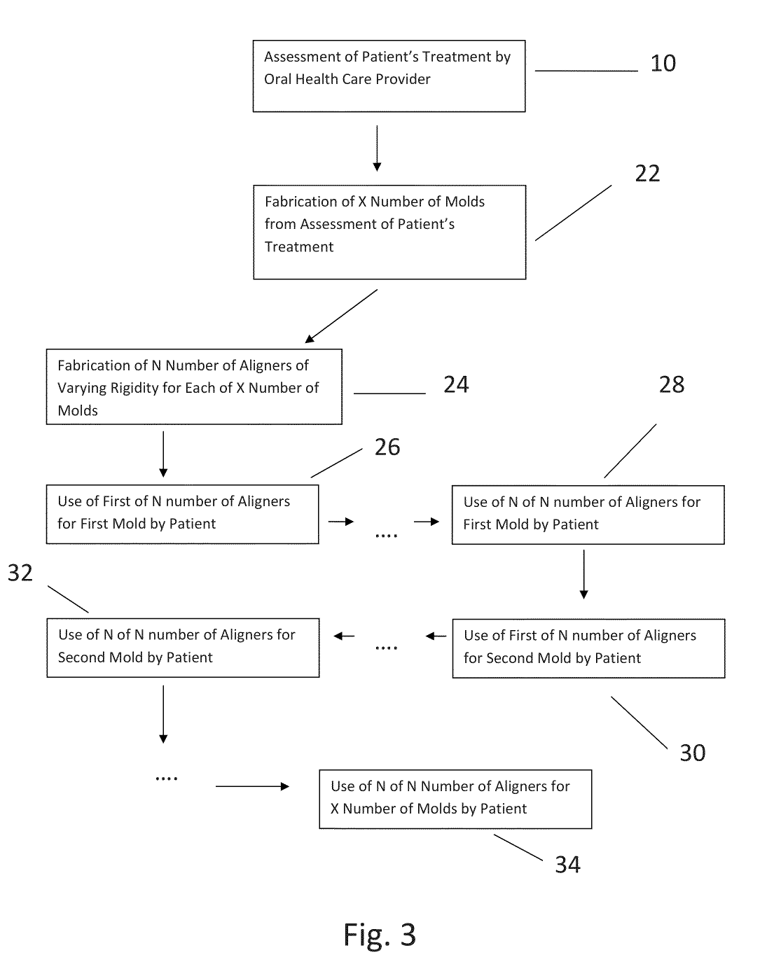

In a related embodiment seen in FIG. 3, a plurality of molds each comprising a different orthodontic configuration may be made for the instances when the degree of required treatment is great and exceeds the practical or desirable range of rigidity available for the composition of the aligners. For example, after the assessment of the patient of the oral health care provider occurs in step 10, a plurality of molds are fabricated from the patient's assessment in step 22. Each of the plurality of molds represents a substantial step or benchmark in the progress of the patient's treatment. In step 24, a plurality of aligners are made for each of the plurality of molds. In other words, for each mold that is made, a series of progressively rigid aligners corresponding to that mold is also made. The patient begins their portion of the treatment in step 26 by using the first of N number of aligners for the first fabricated mold. The patient uses the first series of aligners for the first mold as described above in step 28, wherein each successive aligner used comprises an increasing rigidity in order to effectuate the movement of the tooth or teeth. Once the patient's treatment has reached a predetermined point or after the first molded configuration for the aligner has reached its maximum effectiveness, a second series of aligners for a second molded configuration is implemented in step 30 for the patient's treatment. The patient then continues treatment by using a second series of aligners all comprising the second molded configuration, each successive aligner comprising an increased stiffness or rigidity as discussed above in step 32. The process of giving the patient a new series of aligners based on a plurality of molded configurations may be repeated for as long as required by the oral health care provider or until the desired final position of the tooth or teeth is obtained in step 34. Instead of 20-30 different configurations of the mold being made as is used in the prior art, a much smaller number, such as 2-6 different configurations of the mold for the aligners only need to be made. Each configuration of the mold therefore represents a touchstone or significant stage in the progress of the orthodontic treatment of the tooth or teeth being moved.

In another embodiment, the aligner may be replaced in whole or part by a resilient mesh or wire mesh held in a retainer or other appliance(s), which mesh stretches over the misaligned teeth, and pushes, pulls, and/or molds the tooth or teeth into position, allowing only one or two appliances to do what a large number of aligners is now required to perform.

Is to be expressly understood however that other means now known or later devised for varying the thickness of the orthodontic aligners such as the use of small holes, mesh, and the like, may also be used without departing from the original spirit and scope of the invention.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A method for applying orthodontic forces to at least one tooth of a patient comprising:
fabricating an orthodontic mold for the at least one tooth, wherein the orthodontic mold comprises a configuration to apply orthodontic forces to move the at least one tooth to a final desired position;
fabricating a series of aligners derived from the orthodontic mold, wherein each successive aligner in the series comprises an increased rigidity;
applying the series of aligners in succession to the at least one tooth of the patient; and
applying a final aligner in the series of aligners to the at least one tooth, wherein the final aligner comprises the greatest amount of rigidity out of the series of aligners.

2. The method of claim 1 where the configuration of the orthodontic mold comprises the final position and orientation of the at least one tooth to be moved.

3. The method of claim 1 where fabricating a series of aligners from the orthodontic mold comprises varying the thickness of each of the aligners so that each successive aligner in the series is increasingly rigid.

4. The method of claim 1 where fabricating a series of aligners from the orthodontic mold comprises fabricating the series of aligners out of plastic or polymeric material and varying the composition of the plastic or polymeric material so that each successive aligner in the series is increasingly rigid.

5. The method of claim 1 where fabricating a series of aligners from the orthodontic mold comprises fabricating the series of aligners from a plurality of laminate layers and varying the number of laminate layers so that each successive aligner in the series is increasingly rigid.

6. The method of claim 1 where fabricating a series of aligners from the orthodontic mold comprises fabricating each of the series of aligners with at least one portion comprising a different degree of rigidity from at least one remaining portion of the aligner.

7. The method of claim 1 where applying the series of aligners in succession to the at least one tooth of the patient comprises exchanging a first aligner in the series for a next successive aligner in the series of aligners, the next successive aligner comprising an increased rigidity over the first aligner.

8. The method of claim 7 further comprising continually exchanging a currently applied aligner for the next aligner in the series until the final aligner in the series is received.

9. A method for applying orthodontic forces to at least one tooth of a patient comprising:
fabricating a series of orthodontic molds for the at least one tooth, wherein each orthodontic mold comprises a configuration to apply orthodontic forces to move the at least one tooth to a desired position;
fabricating a sub-series of aligners derived from each of the series of orthodontic molds, wherein each successive aligner in each sub-series comprises an increased rigidity; and
applying each sub-series of aligners corresponding to the series of orthodontic molds in succession to the at least one tooth of the patient.

10. The method claim 9 where applying each sub-series of aligners corresponding to the series of orthodontic molds in succession to the at least one tooth of the patient comprises applying a first sub-series of aligners to the at least one tooth, wherein the first sub-series of aligners corresponds to the configuration of a first orthodontic mold of the series of orthodontic molds.

11. The method of claim 9 where applying each sub-series of aligners corresponding to each of the plurality of orthodontic molds in succession to the at least one tooth of the patient comprises exchanging a first aligner in the sub-series for a next successive aligner in the sub-series of aligners, the next successive aligner comprising an increased rigidity over the first aligner.

12. The method of claim 10 further comprising continually exchanging a currently applied aligner for the next aligner in the sub-series until a final aligner in the sub-series is received.

13. The method of claim 10 further comprising exchanging the first sub-series of aligners for a next successive sub-series of aligners, the next successive sub-series of aligners corresponding to a successive orthodontic mold.

14. The method of claim 13 further comprising continually exchanging a currently applied sub-series of aligners for the next sub-series of aligners corresponding to the next successive orthodontic mold until a final sub-series of aligners corresponding to a final orthodontic mold is received.

15. The method of claim 9 where fabricating a sub-series of aligners derived from each of the series of orthodontic molds comprises varying the thickness of the aligners in each sub-series so that each successive aligner within each sub-series is increasingly rigid.

16. The method of claim 9 where fabricating a sub-series of aligners derived from each of the series of orthodontic molds comprises fabricating each sub-series of aligners out of plastic or polymeric material and varying the composition of the plastic or polymeric material so that each successive aligner within each sub-series is increasingly rigid.

17. The method of claim 9 where fabricating a sub-series of aligners derived from each of the series of orthodontic molds comprises fabricating each sub-series of aligners from a plurality of laminate layers and varying the number of laminate layers so that each successive aligner within each sub-series is increasingly rigid.

18. The method of claim 9 where fabricating a sub-series of aligners derived from each of the series of orthodontic mold comprises fabricating each sub-series of aligners with at least one portion of the aligner comprising a different degree of rigidity from at least one remaining portion of the aligner.
